(19) United States
(12) Patent Application Publication
(10) Pub. No.: US 2014/0355000 A1
(43) Pub. Date: Dec. 4, 2014

(54) DRIVE CONTROL METHOD OF OPTICAL COHERENCE TOMOGRAPHY APPARATUS

(71) Applicant: CANON KABUSHIKI KAISHA, Tokyo (JP)

(72) Inventor: Takeshi Uchida, Tokyo (JP)

(21) Appl. No.: 14/361,504

(22) PCT Filed: Nov. 26, 2012
(86) PCT No.: PCT/JP2012/081222

§ 371 Date: May 29, 2014

(30) Foreign Application Priority Data
Nov. 30, 2011 (JP) 2011-261591

(51) Int. Cl. G01B 9/02

(52) U.S. Cl. CPC G01B 9/02001; G01B 9/02091
USPC 356/456

(57) ABSTRACT

A drive control method of an SD-OCT system which includes a light source including an SLD, which is a superluminescent diode, and a drive control unit that drive-controls the SLD, and a spectroscope including a linear sensor, and performs a spectroscopic process on returned light, which is emitted from the light source and passes through a reference optical system and an irradiation optical system, by using the spectroscope and obtains an optical coherence tomographic image based on spectrum information of light obtained by the spectroscopic process. When the drive control unit generates a drive waveform having three or more current values and periodically changes the drive waveform to one of the current values, the period is set to an integer multiple of a period in which the linear sensor acquires the spectrum information and a spectral shape is controlled to be a shape required by the SD-OCT system.

### TECHNICAL FIELD

The present invention relates to a drive control method of an optical coherence tomography apparatus.

### BACKGROUND ART

An OCT (Optical Coherence Tomography) system or apparatus is known as a system or an apparatus used to acquire an optical tomographic image of a biological tissue or the like.

In particular, as disclosed in Japanese Patent Laid-Open No. 2009-283736 (herein referred to as “PTL 1”), an SD (Spectral Domain)-OCT system is known as a system that emits light from a light source having a broadband spectral width and acquires an optical tomographic image by using a spectroscope that acquires a spectrum of light interfered in an OCT optical system.

As described in PTL 1, the larger the acquired spectral width, the higher the resolution of the tomographic image.

Therefore, in an application of the SD-OCT system, a broadband light source is required. For example, when a resolution of 5 μm is required, a spectral range of about 90 nm is required around a wavelength of 850 nm.

In the OCT optical system, it is necessary to couple the light from the light source to an optical fiber.

Therefore, as characteristics required to the light source, it is required that the spectrum of the light of light source is broadband and can be efficiently coupled to an optical fiber.

As a light source having such characteristics, a superluminescent diode (SLD) is known.

Although the SLD has a device configuration similar to a semiconductor laser, the SLD has a structure that suppresses laser oscillation.

Specifically, an angle of an optical waveguide direction determined by a ridge structure or the like to a device end surface is tilted by a range from 5° to 15° from the vertical direction, so that reflection of light is suppressed on the device end surface.

A structure is often used in which an anti-reflective coating formed of a dielectric material is applied to the device end surface to reduce reflectivity. Specifically, a reflectivity of 0.1% or less is desired.

Since the SLD has a structure where resonance is suppressed in this way, a relatively large gain spectral range of an active layer is strongly reflected to a spectrum emitted from a device. Therefore, the SLD has characteristics to emit incoherent light having a large spectral range in the similar manner as an LED.

Therefore, in the SD-OCT system, the SLD can be used as a light source.

However, when using an active layer structure that is often used in a normal semiconductor laser, more specifically, a structure in which a plurality of quantum wells having the same structure are arranged as an active layer, it is difficult to increase the bandwidth as much as required by the SD-OCT even though the spectral width is wider than that of a semiconductor laser.

Therefore, as a method for increasing a bandwidth of an emission spectrum to a level required by the SD-OCT system in the SLD, a structure called “asymmetric quantum well” is used, in which a plurality of quantum wells having different emission wavelengths are included in one waveguide structure as an active layer.

PTL 1 discloses an SLD in which two quantum wells having different emission wavelengths are used as an active layer to increase bandwidth. According to the above SLD, it is possible to realize a wavelength width of 84 nm.

By the way, in the SD-OCT system, the shape of the spectrum as well as the increase of the bandwidth affects the quality of a final tomographic image.

For example, as an example of the required shape, the spectral shape of the light source is desired to be a unimodal spectral shape because an acquired spectrum is converted into a tomographic image by Fourier transform.

Thereby, it is possible to prevent deterioration of S/N when the Fourier transform is performed and generation of spurious signal, so that the quality of the tomographic image can be improved.

As described above, there is an optimal spectral shape required by the system, so that the SLD, which is the light source, is desired to satisfy the requirement.

On the other hand, in the SLD, which is an actually used light source, as described in PTL 1, although the emission wavelength can be increased by an asymmetric quantum well structure, it is difficult to control the spectral shape to be unimodal even when the asymmetric quantum well structure is introduced.

In particular, when increasing a drive current to increase an output, light emission of shortwave side is intensified from a certain level, so that it is difficult to realize a unimodal spectral shape which has a peak at the center of the shape.

Although, it is possible to control the spectral shape to some extent by changing a structural parameter of the asymmetric quantum well structure and the like, if design change is performed so that the position of the quantum well is largely shifted from an optimal position, factors other than the spectral shape, specifically, light output, efficiency, device lifetime, and the like may be deteriorated.

As described above, in the actual SLD, there is a limit to a range in which the parameters to control the structure of the asymmetric quantum well and an spectrum of injection current and the like can be controlled, so that it is difficult to realize a spectral shape required by the system, for example, a unimodal spectral shape.

The essential causes of this problem are that there is a limit to a variable range of control parameters and the number of parameters that control the shape is small. The above causes make it more difficult to solve the problem.

### CITATION LIST

### Patent Literature

PTL 1 Japanese Patent Laid-Open No. 2009-283736

### SUMMARY OF INVENTION

In view of the above problem, the present invention provides a drive control method of an optical coherence tomography apparatus that can easily control the spectral shape to be a shape required by the system or the apparatus.

The drive control method of an optical coherence tomography apparatus provided by the present invention is a drive control method of an optical coherence tomography apparatus which includes a light source including a superluminescent diode and a drive control unit that drive-controls the superluminescent diode and a spectroscope including a sensor and performs a spectroscopic process on returned light, which is emitted from the light source and passes through a reference optical system and an irradiation optical system, by using the spectroscope and obtains an optical coherence tomographic image on the basis of spectrum information of light obtained by the spectroscopic process.

When the drive control unit generates a drive waveform having three or more current values and periodically changes the drive waveform to one of the current values, the period is set to an integer multiple of a period in which the sensor acquires the spectrum information and a spectral shape is controlled to be a shape required by the optical coherence tomography apparatus.

The present invention includes an optical coherence tomography method.

The optical coherence tomography method of the present invention is an optical coherence tomography method which performs a spectroscopic process on returned light, which is emitted from the light source including a superluminescent diode and a drive control unit that drive-controls the superluminescent diode and passes through a reference optical system and an irradiation optical system, by using a spectroscope including a sensor and obtains an optical coherence tomographic image on the basis of spectrum information of light obtained by the spectroscopic process.

The drive control unit generates a drive waveform having three or more current values, periodically changes the drive waveform to one of the current values, and sets the period to an integer multiple of a period in which the sensor acquires the spectrum information.

Further features of the present invention will become apparent from the following description of exemplary embodiments with reference to the attached drawings.

### BRIEF DESCRIPTION OF DRAWINGS

FIG. 1 is a diagram for explaining a structure of an SLD used in a first embodiment of the present invention.

FIGS. 2A, 2B, and 2C are diagrams for explaining a calculation result of a spectral shape when driving the SLD having a device structure used in the first embodiment of the present invention by a constant current or a modulated current.

FIGS. 3A and 3B are diagrams for explaining a temporally integrated spectral shape when changing the drive current in the first embodiment of the present invention.

FIG. 4 is a diagram for explaining a drive control method of an SD-OCT system using the SLD in the first embodiment of the present invention.

FIG. 5 is a diagram for explaining an SLD device structure in a second embodiment of the present invention.

FIGS. 6A and 6B are diagrams for explaining a drive control method for a unimodal spectrum in the second embodiment of the present invention.

FIGS. 7A and 7B are diagrams for explaining a drive control method for a rectangular spectrum in the second embodiment of the present invention.

FIG. 8 is a diagram for explaining a drive control method of an SD-OCT system using the SLD in the second embodiment of the present invention.

### DESCRIPTION OF EMBODIMENTS

A drive control method of an optical coherence tomography apparatus using a superluminescent diode (SLD) of the present invention is configured to acquire an optical tomographic image from an optical spectrum that reaches a spectroscope.

When calculating a tomographic image from the spectrum, it is necessary to use a spectral shape of a light source in the calculation.

Therefore, as characteristics of the SLD, it is desired that the spectrum is stable. For example, in PTL 1 described above, the SLD is driven by a constant current.

When the current that drives the SLD is changed, not only the intensity of emitted light, but also the spectral shape is changed according to the change of the current.

Therefore, when the current is simply changed, the spectral shape of the light source, which should be used in the calculation, is intricately changed, so that it is easily assumed that adverse affects occur due to complexity of the calculation and accuracy degradation of the calculation.

Here, characteristic of the spectroscope, which acquires a spectrum and is used in an OCT system (OCT apparatus), will be further studied.

The spectroscope mainly includes a grating and a linear sensor behind the grating.

The grating has an effect to separate diffraction directions for each wavelength. Thereby, the light proceeding direction in space changes for each wavelength. Therefore, the intensity of a spectrum can be acquired by receiving intensities of the light that proceeds in each direction by the linear sensor.

Here, the relationship between the light source and the linear sensor is studied in detail and the following things are found:

The linear sensor has a mechanism that accumulates charge according to incident light in a photo detector in a certain period of time and reads the amount of charge after a certain period of time.

When the light output that enters the photo detector changes in the carrier accumulation time, the read amount of charge is an integrated value of the light output. Therefore, in an SD-OCT system, the change in the certain period of time in which the charge is accumulated is actually equivalent to a case in which a certain amount of light enters by the average of the light output.

In other words, in the SD-OCT system, when the amount of light integrated in the carrier accumulation time of the linear sensor is the same, even if there is a change in the carrier accumulation time, the amount of light is recognized as a stable amount of light by the system.

When the drive current is actually changed, a carrier occupancy level to a state density in a quantum well changes accordingly in the SLD, so that a gain spectrum changes. As a result, the spectrum of the light emitted from the SLD changes.

Therefore, if a change of light is repeated in a unit of the carrier accumulation time of the linear sensor, the amount of light of each spectral component is seen stable for each data acquisition of the linear sensor, and the spectral shape can be changed.

As a result, in the SD-OCT system, it is found that the spectral shape can be controlled by the method described below as a method for controlling an equivalent spectral shape of the light source as seen from the system in addition to a method that changes the structure of the quantum well.

Specifically, it is found that equivalent spectral shape can be more freely controlled by a new control method in which the drive current of the SLD is driven by a modulated waveform having the same period as that of the linear sensor or having a period which is an integral multiple of the period of the linear sensor.

Therefore, in the present invention, instead of continuously driving the SLD at a constant current, the SLD is driven with a current of a wave having a certain period as one of spectrum control units.

Thereby, the number of parameters that control the spectral shape increases, so that it is possible to obtain a spectrum that is nearer to the spectrum required by the system.

For example, if the spectral shape can be unimodal, it is possible to improve S/N when Fourier transform is performed and prevent generation of spurious signal, so that a high quality tomographic image can be obtained.

### EMBODIMENTS

Hereinafter, embodiments of the present invention will be described.

### First Embodiment

As a first embodiment, a configuration example of a drive control method of an SD-OCT system to which the present invention is applied will be described.

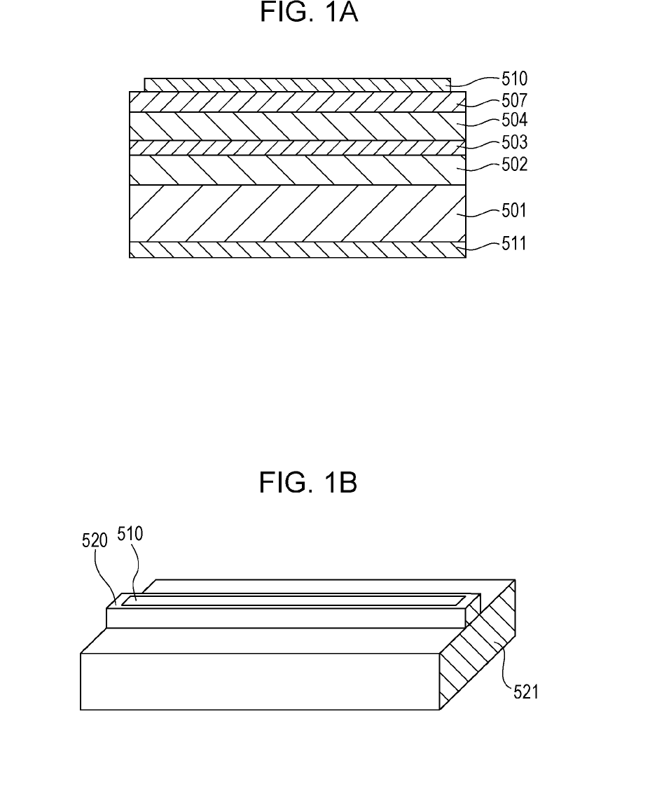

First, a structure of an SLD used in the first embodiment will be described with reference to FIG. 1A. As a layer configuration of the SLD in the vertical direction, an n-clad layer formed of Al_{0.5}Ga_{0.5}As (first conductivity type clad layer) 502 is disposed on an upper part of a GaAs substrate 501 (on a semiconductor substrate).

An active layer 503 including three InGaAs/GaAs quantum wells (not shown in the drawings) is located on the n-clad layer 502.

The active layer 503 is formed by a plurality of, for example, three quantum well layers having different emission wavelengths from the ground level. These emission wavelengths from the ground level are 1050 nm, 978 nm, and 906 nm respectively.

A p-clad layer (second conductivity type clad layer) 504 formed by a p-type Al_{0.5}GaAs layer is disposed on the active layer 503.

A contact layer 507 formed of a heavily doped p-type GaAs having a thickness of 10 nm is located on the p-clad layer 504.

A second electrode 510 which is electrically in contact with the contact layer 507 is disposed above the contact layer 507.

A first electrode 511, which is on the back surface of the substrate and electrically in contact with the substrate 501, is disposed below the substrate 501.

Regarding the device shape of the SLD, as shown in FIG. 1B, the p-clad layer 504 and the contact layer 507 are partially removed to the middle of the p-clad layer and the remaining portion forms a ridge shape 520 having a width of 4 μm.

The length of the ridge is 1 mm and the second electrode 510 is formed above the ridge. The end surface of the ridge is a cleaved facet of GaAs crystal and the longitudinal direction of the second electrode of the SLD is tilted from the vertical direction by an angle in a range of 5° to 15°. In this case, it is further preferable that the vertical line of the cleaved facet and the longitudinal direction of the ridge, which are the above tilting, are tilted by 7°. A multilayered dielectric film 521 for controlling the reflectivity is added to the both end surfaces. In this case, the reflectivity is preferred to be 0.1% or less.

A calculation result of a spectral shape when the SLD having such a device structure is driven by a constant current or a modulated current will be described.

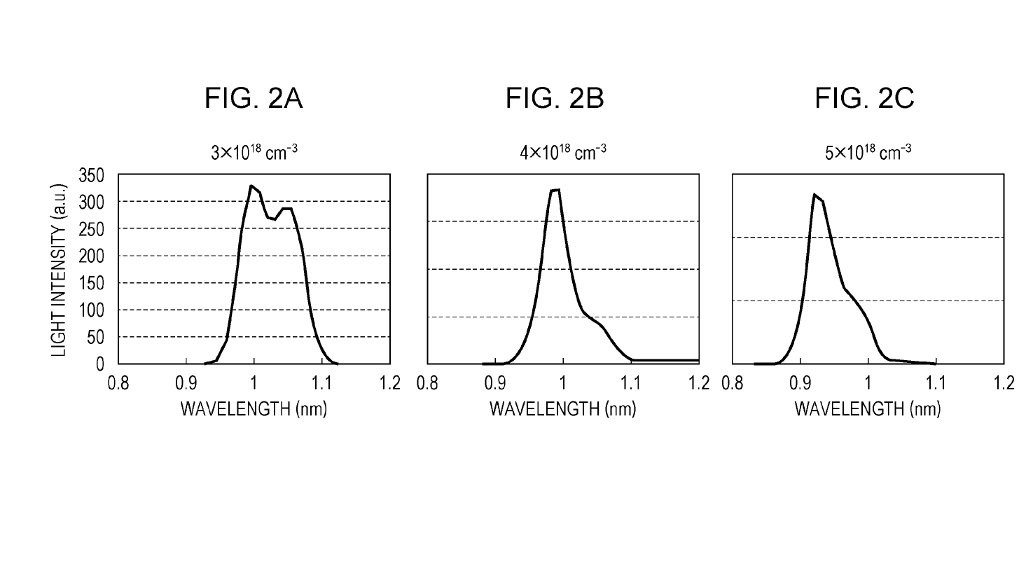

FIGS. 2A, 2B, and 2C show spectra of light outputted by constant currents of 3×10¹⁸ cm⁻³ (FIG. 2A), 4×10¹⁸ cm⁻³ (FIG. 2B), and 5×10¹⁸ cm⁻³ (FIG. 2C), respectively.

In the case of 3×10¹⁸ cm⁻³ shown in FIG. 2A, there is two peaks. However, when the injection current is increased and the carrier density is increased, light emission of shorter wave side is intensified as shown in FIGS. 2B and 2C.

Therefore, even when the current is increased to control the spectrum, the light emission intensity from the shorter wave side increases, so that it is difficult to obtain a unimodal spectral shape required by the OCT system.

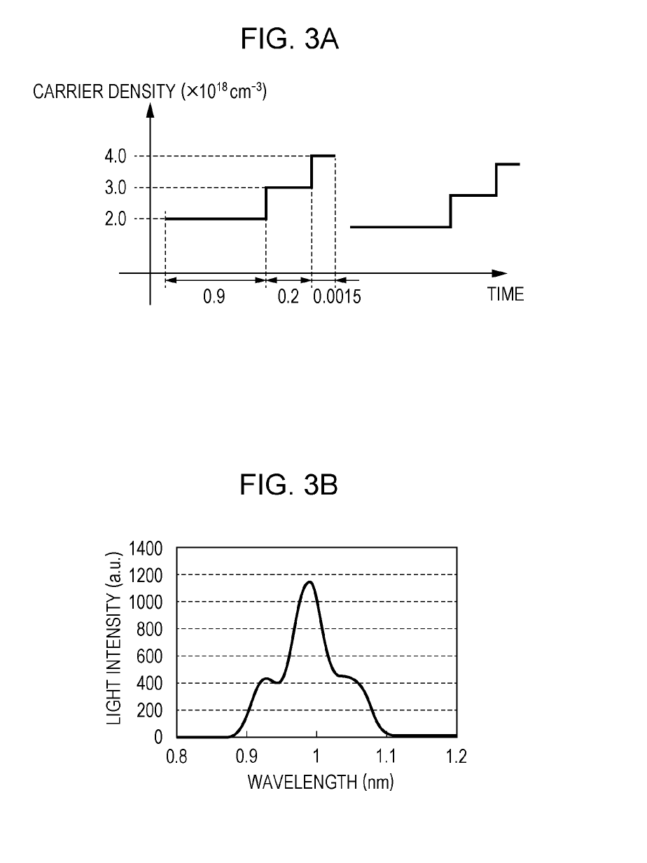

On the other hand, FIGS. 3A and 3B show a temporally integrated spectra shape when the drive current is changed, that is, a spectra shape as seen from the OCT system.

FIG. 3A shows a waveform and a current value of a modulated current to be applied.

The unit of the current is represented as a carrier density in the active layer of the SLD instead of a current value itself in order to compare with the above description.

The current value to be applied is a drive current waveform that is formed by three levels of steps. The carrier densities corresponding to each step are the same as the carrier densities at certain currents in FIGS. 2A, 2B, and 2C, respectively.

The time in FIG. 3A is relative, so that if the ratio is not changed, the integrated spectrum is not changed.

Therefore, while the ratio is maintained, if the period is set to an integer multiple of data acquisition period of the linear sensor, the SLD can be seen as a stable light source from the system.

FIG. 3B shows an integrated shape of the spectrum formed by the modulated waveform shown in FIG. 3A.

From FIG. 3B, it is found that the spectral shape is unimodal having its peak at the center as compared with the spectral shape of the constant current drive.

Although, in FIGS. 2A, 2B, and 2C, such a unimodal shape cannot be obtained even when the current value is changed, it is possible to more freely control the spectral shape of light emitted from the SLD by modulating the current even when driving the SLD in a range of the same drive current as shown in FIG. 3B. It is found that a unimodal spectral shape having its peak at the center can be realized.

The modulation condition to form the spectral shape into a unimodal shape is determined by the length of the device, the spectral shape of the active layer, and the like.

Therefore, the modulation condition shown in FIG. 3A is an optimal condition for the device. However, it is not a common condition for all SLDs.

Important factors to determine the drive condition are the shape of the gain spectrum of the device, the dependency to the carrier density of the device, and the length of the device.

It is important to change the drive waveform at certain time intervals while flowing a current and maintaining sufficient intensity of light output.

This is because the spectral shape of emitted light changes and the spectral shape has a shape whose integrated spectrum of emitted light is equivalent at each state, so that a certain level of light intensity is required to the spectrum to be integrated.

In other words, a pulse drive used in a semiconductor laser or the like, that is, a two-valued drive method in which a pulse is driven by either one of two predetermined current values and after a certain period of time, the pulse is driven by the other current value, is not suitable.

This is because, in the pulse drive used in a semiconductor laser or the like, it is set so that the light output is low during a low level drive (corresponding to “0” in optical communication) and the light output is high during a high level drive (corresponding to “1” in optical communication).

The difference is required as a signal, so that the drive condition is determined so that the difference increases as much as possible within an allowed range.

On the other hand, in the first embodiment, the light output is desired to be the same level as much as possible. Further, the larger the number of the patterns of the original spectral shape to be integrated, the more freely the integrated spectral shape can be controlled.

In other words, the drive waveform of a step shape having three or more current levels as shown in the first embodiment or a drive waveform in which current changes continuously is preferable.

Next, a manufacturing process of the device in the first embodiment will be described.

First, semiconductor layers including the n-clad layer 502, the active layer 503, the p-clad layer 504, and a contact layer 507 are grown on the GaAs substrate 501 by an organometallic vapor phase epitaxy or a molecular beam epitaxy method.

A dielectric film is formed on a wafer of the above layers by using a sputtering method.

Thereafter, a stripe forming mask for forming a ridge by a photoresist is formed by using photolithography.

The semiconductor other than a portion of the stripe forming mask is selectively removed by using a dry etching method and a ridge shape having a height of 0.5 μm is formed.

Thereafter, SiO₂ is formed on the surface of the semiconductor and the SiO₂ on the upper portion of the ridge is partially removed by a photolithography method.

Next, p side and n side electrodes 510 and 511 are formed by using a vacuum deposition method and photolithography. To obtain good electrical characteristics, the electrodes and the semiconductor are alloyed in a high-temperature nitrogen atmosphere. Finally, a crystal surface is exposed on the end surfaces by cleaving and a dielectric film for adjusting the reflectivity is coated on both end surfaces. Thus, the SLD is completed.

The SLD completed in this way is mounted on the SD-OCT system and driven by the drive waveform shown in FIG. 3A, so that the spectral shape shown in FIG. 3B can be obtained.

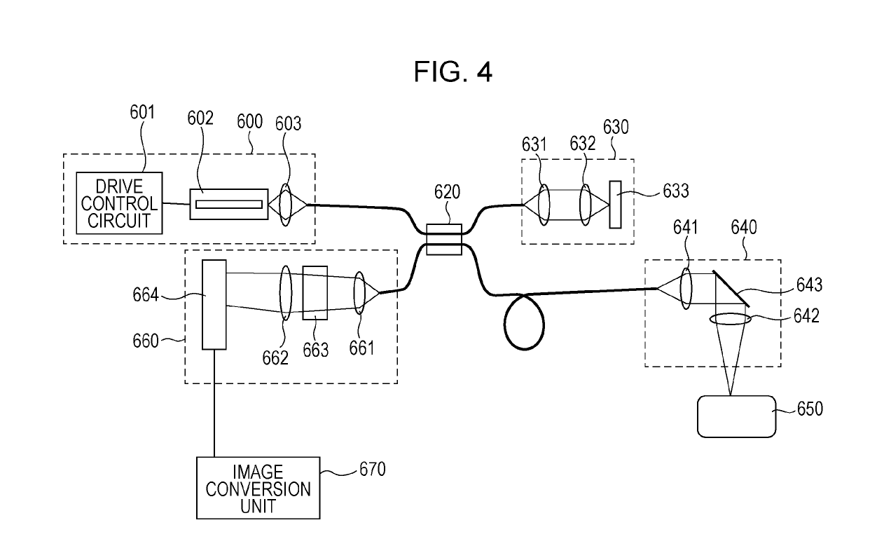

FIG. 4 shows the SD-OCT system including the SLD formed in the manner as described above. The system includes a light source unit 600, a light coupling unit 620 for coupling fibers to each other, a reference optical system (reference light reflection unit) 630, an irradiation optical system 640 for irradiating light to a measurement object 650, a spectroscope 660, and an image conversion unit 670 for converting spectrum information into an image.

The light source unit 600 includes a drive control circuit 601 that generates a predetermined drive waveform, an SLD 602 shown in FIG. 1, and a lens 603 that couples light to an optical fiber.

When the drive control circuit 601 drives the SLD 602, the drive control circuit 601 can generate a drive waveform having three or more current values and periodically change the drive waveform to one of the current values. Here, the light emitted from the SLD 602 enters the optical fiber through the lens 603.

A part of light separated by the light coupling unit 620 enters the reference light optical system 630.

The reference light optical system 630 includes collimator lenses 631 and 632 and a reflecting mirror 633. The light entering through the light coupling unit 620 is reflected by the reflecting mirror 633 and enters the optical fiber again as returned light.

The other light separated by the light coupling unit 620 enters the irradiation optical system 640. The irradiation optical system 640 includes collimator lenses 641 and 642 and a reflecting mirror 643 that bends an optical path by 90°.

The irradiation optical system 640 emits incident light to the measurement object 650 and re-couples the reflected light to the optical fiber.

As a circuit that can be used as the drive control circuit 601, it is possible to use a publicly known drive circuit for an edge emitting laser as disclosed in US patent No. 2010/0183318. The SLD 602 is driven by such a drive circuit, so that it is possible to realize predetermined current values and the carrier densities shown in FIG. 3A and the like.

The light returned from the reference optical system 630 and the irradiation optical system 640 passes through the light coupling unit 620 and enters the spectroscope 660 that performs a spectroscopic process on the light.

The spectroscope 660 includes collimator lenses 661 and 662, a grating 663 that diffracts light, and a linear sensor 664 that obtains spectrum information of the light diffracted by the grating.

The spectroscope 660 has a configuration to obtain spectrum information of the light that enters the spectroscope 660.

The information obtained by spectroscope 660 is converted into an image by the image conversion unit 670 that converts the information into an optical tomographic image of the measurement object 650, and tomographic image information, which is the final output, is obtained.

### Second Embodiment

As a second embodiment, a configuration example will be described which is different from the first embodiment and in which two or more electrodes are formed on either one of the first conductivity type clad layer and the second conductivity type clad layer.

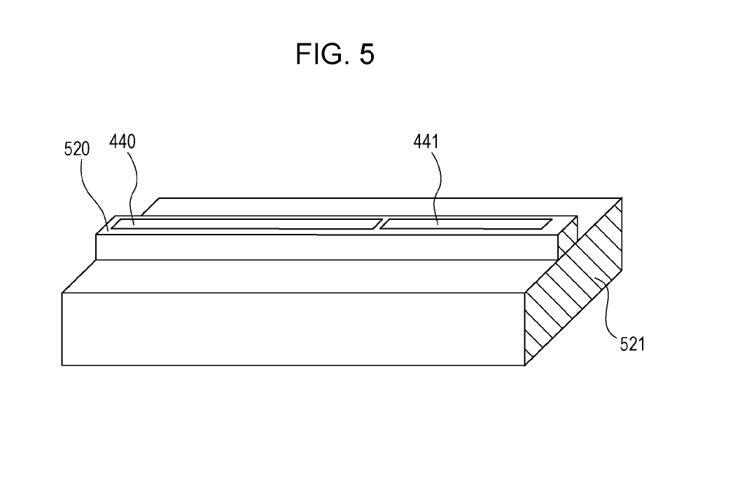

First, a structure of an SLD used in the second embodiment will be described with reference to FIG. 5.

In the second embodiment, the configuration of the semiconductor is the same as that of the first embodiment. However, in the second embodiment, as shown in FIG. 5, two electrodes (440 and 441) are disposed on an upper portion of the ridge 520 and the two electrodes are electrically separated from each other.

These electrodes are electrically in contact with the p-clad layer 504. In the first embodiment, there is one electrode, so that the entire device is driven by one waveform and the spectrum is controlled.

On the other hand, in the second embodiment, it is possible to flow current in each of the two electrodes individually, so that the degree of freedom of the spectrum control can be increased.

The second embodiment has a device structure in which the length of the electrode 440 is 1 mm and the length of the electrode 441 is 0.5 mm. The width of the ridge 520 is the same as that of the first embodiment. The device structure of the second embodiment is the same as that of the first embodiment except that there are two electrodes and thereby the length of the device is elongated.

Although light is emitted from both end surfaces, the light emitted from the end surface of the side of the electrode 441 is brought into the system and used.

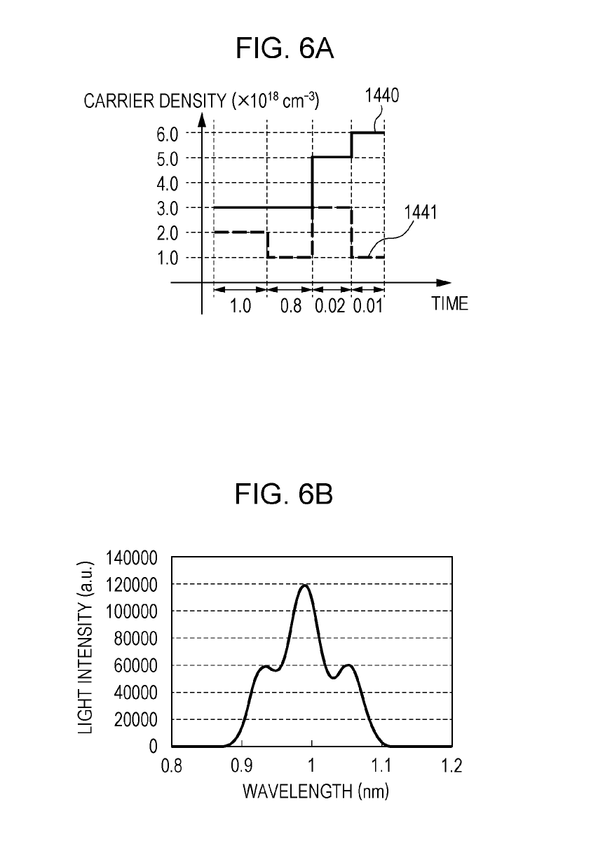

FIGS. 6A and 6B show the drive condition and the spectral shape in the second embodiment.

FIG. 6A shows the drive waveforms of the two electrodes. The solid line 1440 represents a drive waveform for driving the electrode 440 and the dashed line 1441 represents a drive waveform for driving the electrode 441. In FIG. 6A, different drive waveforms are inputted into the two electrodes respectively. The currents change to three different levels.

FIG. 6B shows an integrated spectrum of emitted light when the SLD in FIG. 5 is driven by the drive method shown in FIG. 6A.

From FIG. 6B, it is found that a unimodal spectral shape can be realized also in the second embodiment.

In a viewpoint that a unimodal spectral shape can be realized, the second embodiment is the same as the first embodiment. However, in the second embodiment, a ratio of constant value holding times in the drive waveform can be smaller than that of the first embodiment. This is an advantage of the second embodiment.

Specifically, in the drive waveform of the first embodiment, as shown in FIG. 3A, the longest holding time is 0.9 and the shortest holding time is 0.0015. In other words, a ratio of the longest time to the shortest time is 600.

On the other hand, in the second embodiment, the longest holding time is 1.0 and the shortest holding time is 0.01, so that the ratio of these is 100. In this way, in the second embodiment, the ratio of the holding times can be reduced.

The repetition period of the drive waveform is determined by the reading period of the linear sensor.

Therefore, the ratio of the holding times can be small, so that the required frequency characteristics are low.

On the other hand, in the first embodiment, it is necessary to reliably flow a current in a short period of time, so that an electrical circuit of higher drive performance is required.

As characteristics of the drive waveform, there is a portion in which the carrier density is 1×10¹⁸ cm⁻³.

In a case of the quantum well of the second embodiment, the carrier density of 1×10¹⁸ cm⁻³ is lower than a level at which optical gain (stimulated emission) occurs. In other words, the SLD is driven by a carrier density lower than the transparency carrier density. In the second embodiment, the transparency carrier density is 1.5×10¹⁸ cm⁻³. As described above, the SLD is driven by a drive current of a level at which the stimulated emission occurs because the SLD operates using the stimulated emission. Specifically, the SLD is driven by a drive current larger than or equal to the transparency carrier density.

On the other hand, in the second embodiment, in addition to the stimulated emission, a drive by a drive current smaller than or equal to the transparency carrier density is also performed.

This is to control the shape of a part of the stimulated emission light generated in the active layer in a region below the electrode 440 by an absorption spectrum of the active layer below the electrode 441.

By employing such a two-electrode structure and also using a spectrum of a carrier injection level lower than or equal to the transparency carrier density, it is possible to realize the same unimodal spectral shape as that of the first embodiment even at a low ratio of the holding times as described above.

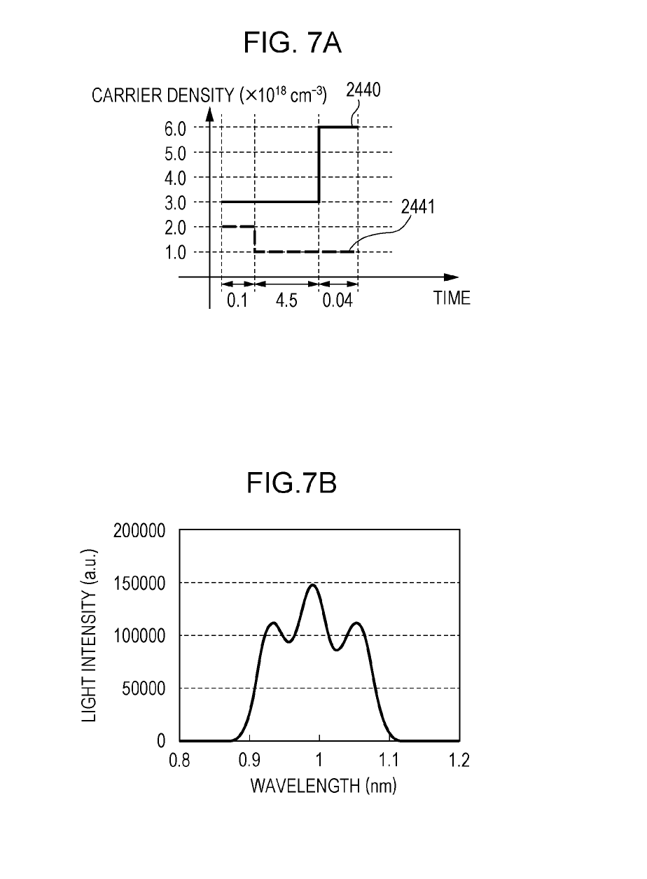

Further, the number of electrodes increases, so that the spectrum can be more freely controlled. In FIG. 7B, a spectrum having a shape near to rectangular compared with the spectrum shown in FIG. 6B is realized.

FIG. 7A shows drive waveforms. In FIG. 7A, the solid line 2440 represents a drive waveform for driving the electrode 440 and the dashed line 2441 represents a drive waveform for driving the electrode 441.

FIG. 7B shows an integrated spectrum when the SLD of the second embodiment is driven by the drive waveforms shown in FIG. 7A.

Although, FIG. 6B shows a unimodal spectral shape, FIG. 7B shows a spectrum having a shape near to rectangular. Therefore, it is found that even when the same SLD is used, if the drive waveforms are changed, the spectral shape can be freely changed.

From FIGS. 6A, 6B, 7A, and 7B, it is found that the characteristics of the light source can be freely changed by only changing the waveforms according to a request of the system and a type of image to be obtained.

For example, when it is desired to prioritize a full width at half maximum of the spectrum, in other words, when it is desired to increase the resolution of the OCT image, FIGS. 7A and 7B are more preferable to FIGS. 6A and 6B.

On the other hand, when it is desired to obtain an image with a high S/N ratio and less spurious signals, the image can be realized by forming a unimodal spectral shape as shown in FIG. 6B.

In the present invention, the switching of the above can be realized by only changing the drive waveforms of the SLD.

A device manufacturing process of the second embodiment is the same as that of the first embodiment except that the two electrodes 440 and 441 are provided instead of the second electrode 510, so that the description thereof will be omitted.

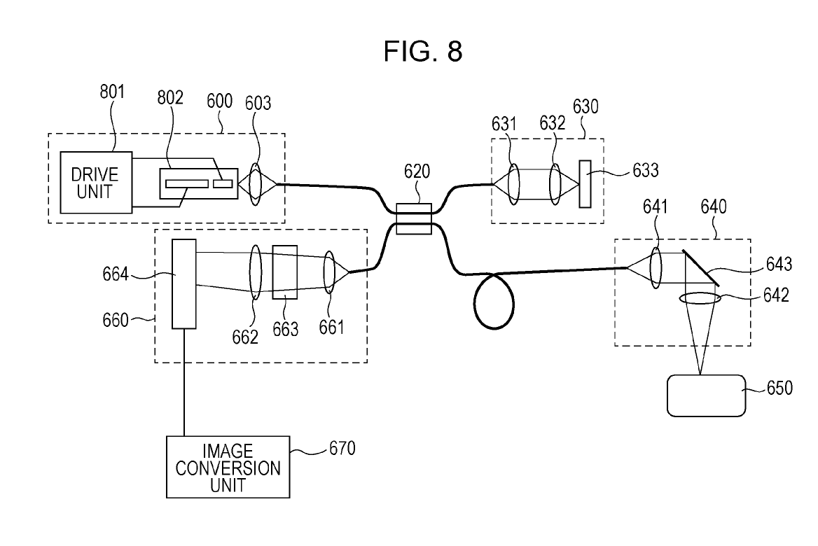

FIG. 8 shows an SD-OCT system using this.

In FIG. 8, the SD-OCT system includes the same components as those shown in FIG. 4 except for an SLD 802 and a drive unit 801 that can drive two electrodes individually, so that the same reference numerals are given. The configuration and functions of the components are also the same as those shown in FIG. 4, so that the description thereof will be omitted.

Although, in the second embodiment, there are two electrodes that are electrically in contact with the p-clad, if there are three or more electrodes, the same effect can be obtained.

As described in the first and the second embodiments, when the number of electrodes is increased from one to two, the degree of freedom of the spectral shape control is increased. In the same manner, when the number of electrodes is increased to three or more, the spectral shape can be more freely controlled.

Therefore, even when three or more electrodes are used, the effect of the present invention can be obtained.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-261591, filed Nov. 30, 2011, which is hereby incorporated by reference herein in its entirety.

### REFERENCE SIGNS LIST

501 GaAs substrate
502 n-clad layer
503 active layer
504 p-clad layer
507 contact layer
510 second electrode
511 first electrode

1. A drive control method of an optical coherence tomography apparatus which includes a light source including a superluminescent diode and a drive control unit that drive-controls the superluminescent diode, and a spectroscope including a sensor, performs a spectroscopic process on returned light which is emitted from the light source and passes through a reference optical system and an irradiation optical system by using the spectroscope, and obtains an optical coherence tomographic image on the basis of spectrum information of light obtained by the spectroscopic process,
wherein when the drive control unit generates a drive waveform having three or more current values and periodically changes the drive waveform to one of the current values, the period is set to an integer multiple of a period in which the sensor acquires the spectrum information and a spectral shape is controlled to be a shape required by the optical coherence tomography apparatus.

2. The drive control method of an optical coherence tomography apparatus according to claim 1, wherein the drive waveform is a step-shaped drive waveform.

3. The drive control method of an optical coherence tomography apparatus according to claim 1, wherein the drive waveform is a drive waveform where a current value continuously changes.

4. The drive control method of an optical coherence tomography apparatus according to claim 1, wherein the spectral shape is unimodal.

5. The drive control method of an optical coherence tomography apparatus according to claim 1, wherein the spectral shape is rectangular.

6. The drive control method of an optical coherence tomography apparatus according to claim 1, wherein the sensor is a linear sensor.

7. The drive control method of an optical coherence tomography apparatus according to claim 1, wherein the superluminescent diode includes a first conductivity type clad layer, a second conductivity type clad layer, and an active layer formed between these clad layers on a semiconductor substrate.

8. The drive control method of an optical coherence tomography apparatus according to claim 7, wherein an end surface of the semiconductor substrate and a longitudinal direction of a second electrode formed on an upper portion of the superluminescent diode are tilted by a range from 5° to 15° from a vertical direction.

9. The drive control method of an optical coherence tomography apparatus according to claim 7, wherein a dielectric film is arranged on an end surface of the semiconductor substrate and a reflectivity of the dielectric film is 0.1% or less.

10. The drive control method of an optical coherence tomography apparatus according to claim 7, wherein a plurality of quantum wells having different emission wavelengths from the ground level are used for the active layer.

11. The drive control method of an optical coherence tomography apparatus according to claim 7, wherein two or more electrodes are formed on either one of the first conductivity type clad layer and the second conductivity type clad layer.

12. The drive control method of an optical coherence tomography apparatus according to claim 11, wherein drive waveforms of the two or more electrodes are different from each other.

13. The drive control method of an optical coherence tomography apparatus according to claim 7, wherein at least one of the drive waveforms is formed by a current that realizes a carrier density lower than a transparency carrier density of the quantum wells used for the active layer.

14. An optical coherence tomography method which performs a spectroscopic process on returned light, which is emitted from the light source including a superluminescent diode and a drive control unit that drive-controls the superluminescent diode and passes through a reference optical system and an irradiation optical system, by using a spectroscope including a sensor, and obtains an optical coherence tomographic image on the basis of spectrum information of light obtained by the spectroscopic process,
wherein the drive control unit generates a drive waveform having three or more current values, periodically changes the drive waveform to one of the current values, and sets the period to an integer multiple of a period in which the sensor acquires the spectrum information.
